(19) United States
(12) Patent Application Publication
(10) Pub. No.: US 2018/0051843 A1
(43) Pub. Date: Feb. 22, 2018

(54) Pipe Multifold Line Plug

(71) Applicant: Kwon J. PARK, Diamond Bar, CA (US)

(72) Inventor: Kwon J. PARK, Diamond Bar, CA (US)

(21) Appl. No.: 15/242,972

(22) Filed: Aug. 22, 2016

(51) Int. Cl. F16L 55/11

(52) U.S. Cl. CPC F16L 55/1141; F16L 55/1108

(57) ABSTRACT

A pipe ML plug is provided. A rubber tube portion is disposed around a length portion of the base rod portion and at the lower end of the base rod portion, extends straight for a specific length. A lower fixer is fixed to the base rod portion and to limit moving of the lower end of the rubber tube portion in a downward direction. The upper fixer disposed at a position of the base rod portion where the upper end of the rubber tube portion is located. The lower fixer and the upper fixer are for fixing a distance therebetween, so as to press the rubber tube portion lengthwise from both of the lower and upper ends to a specific length and thus to make the rubber tube portion bulge to a specific diameter, so that the bulged rubber tube portion blocks and seals an external pipe from inside.

### BACKGROUND OF THE INVENTION

The present invention relates to a pipe multifold line (ML) plug.

Plumbing work under multifold line structure is challenging for many well-known reasons.

In most of the cases, conventional tools for the work turn out to be not that helpful, sometimes almost useless.

Especially, it is very difficult to handle situations that need testing of under-slab water leak, so called “slab leak”.

As discussed before, the maze of pipe lines and the tightness of space there in the multifold line make the problem much worse than in a situation with a regular single line in an open space.

It was quite difficult to block simply a pipe in the middle of the multifold line.

Accordingly, a need for a pipe ML plug has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a pipe ML plug.

An aspect of the invention provides a pipe ML plug, comprising a base rod portion, a rubber tube portion, a lower fixer, and an upper fixer.

The base rod portion of a first length has a lower end and an upper end.

The rubber tube portion is disposed around a length portion of the base rod portion and at the lower end of the base rod portion, has an inner diameter and an outer diameter and extending straight for a second length shorter than the first length of the base rod portion, having a lower end and an upper end, and is configured to increase a blocking diameter when compressed lengthwise.

The lower fixer is disposed at the lower end of the base rod portion so as to be fixed to the base rod portion and to limit moving of the lower end of the rubber tube portion in a downward direction.

The upper fixer disposed at a position of the base rod portion where the upper end of the rubber tube portion is located, so as to be fixed movably to the base rod portion and to limit moving of the upper end of the rubber tube portion in an upward direction.

The lower fixer and the upper fixer are configured for fixing a distance therebetween, so as to press the rubber tube portion lengthwise from both of the lower and upper ends to a specific length and thus to make the rubber tube portion bulge to a specific diameter, so that the bulged rubber tube portion blocks and seals an external pipe from inside.

The pipe ML plug may further comprise an adjuster provided around the base rod portion and configured for pressing on and holding the upper fixer so as to shorten the length of the rubber tube portion and to bulge the diameter of the rubber tube portion to a specific diameter, by engaging with the base rod portion.

The adjuster may comprise a plurality of male threads and a plurality of female threads.

The plurality of male threads are provided on a portion of an outer surface of the base rod portion between the L-shaped pipe portion and the lower end of the base rod portion.

The plurality of female threads are provided on a portion of an inner surface of the adjuster.

The adjuster engages the base rod portion through the male and female threads, so as to adjust the position of the upper fixer along the base rod portion.

The adjuster may be made integrally and monolithically with the upper fixer.

The adjuster may further comprise a first handle portion provided on an outer surface of the adjuster and configured to be held by a user hand for rotating the adjuster.

The adjuster may further comprise a second handle portion provided on an outer surface of the adjuster and configured to be held by a mechanical tool such as a wrench for rotating the adjuster.

Alternatively, the adjuster may comprise a first handle portion and a second handle portion. The first handle portion is provided on an outer surface of the adjuster and configured to be held by a user hand for rotating the adjuster, and a second handle portion is provided on an outer surface of the adjuster and configured to be held by a mechanical tool such as a wrench for rotating the adjuster. The second handle may be disposed on top of the first handle in the length direction of the adjuster.

The rubber tube portion may have an outer diameter substantially same as a diameter of the lower and upper fixers.

The rubber tube portion may be configured configured to be pressed lengthwise to bulge to a diameter larger than an original diameter.

The pipe ML plug may further comprise a hexagon nut disposed fixedly to the lower end portion of the main pipe portion for facilitating to hold or rotate the main pipe portion.

The base rod portion may comprise a plurality of male threads over an entire length.

The pipe ML plug may further comprise a lever handle perpendicularly provided at a top end of the base rod portion, so as to be configured that a user holds or rotate the lever with a single hand, even without a tool, up to 250 psi.

Another aspect of the invention provides that the base rod portion may further comprise a longitudinal hole through the entire length thereof.

The pipe ML plug may further comprise an L-shaped pipe portion and a cap portion.

The L-shaped pipe portion has a lower end vertically connected to the upper end of the base rod portion and an upper end opening horizontally.

The cap portion is disposed at the upper end of the L-shaped pipe portion so as to close or open the upper end of the L-shaped pipe portion.

The upper end is configured to be connected to an air-supplying pipe for leak testing in the external pipe to which the lower portion of the pipe ML plug is inserted and connected.

The L-shaped pipe portion may be connected to the base rod portion through male and female threads.

The advantages of the present invention are: (1) the pipe ML plug according to the invention provides a simple and effective structure; and (2) the pipe ML plug according to the present invention is easy to use in a multifold line situations.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective side view showing a pipe ML plug according to an embodiment of the invention;

FIG. 2 is a perspective bottom view showing the pipe ML plug of FIG. 1 according to an embodiment of the invention;

FIG. 3 is a conceptual diagram showing the pipe multifold line plug with fluid of FIG. 1 with a main pipe portion in solid line and all other components in dashed lines and double short dashed lines; and

FIG. 4 is a partial front views showing a rubber tube portion and lower and upper fixers under different compressing force of the pipe multifold line plug with fluid of FIG. 1.

### DETAILED DESCRIPTION EMBODIMENTS OF THE INVENTION

Referring to the figures, the embodiments of the invention are described in detail.

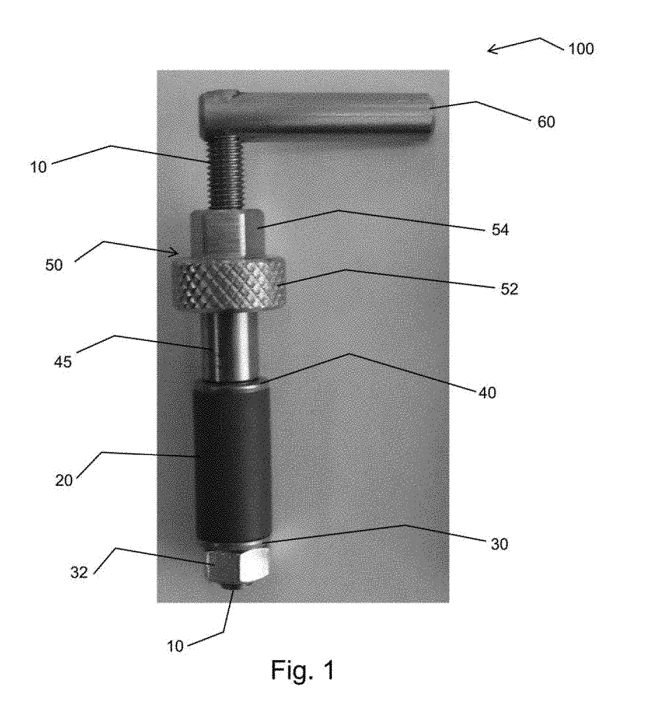

FIGS. 1 through 4 show pipe ML plugs according to embodiments of the present invention.

An aspect of the invention provides a pipe ML plug 100, comprising a base rod portion 10, a rubber tube portion 20, a lower fixer 30, and an upper fixer 40 as shown in FIG. 1.

The base rod portion 10 of a first length has a lower end and an upper end.

The rubber tube portion 20 is disposed around a length portion of the base rod portion 10 and at the lower end of the base rod portion 10, has an inner diameter and an outer diameter and extending straight for a second length shorter than the first length of the base rod portion 10, having a lower end and an upper end, and is configured to increase a blocking diameter when compressed lengthwise as shown in FIG. 4.

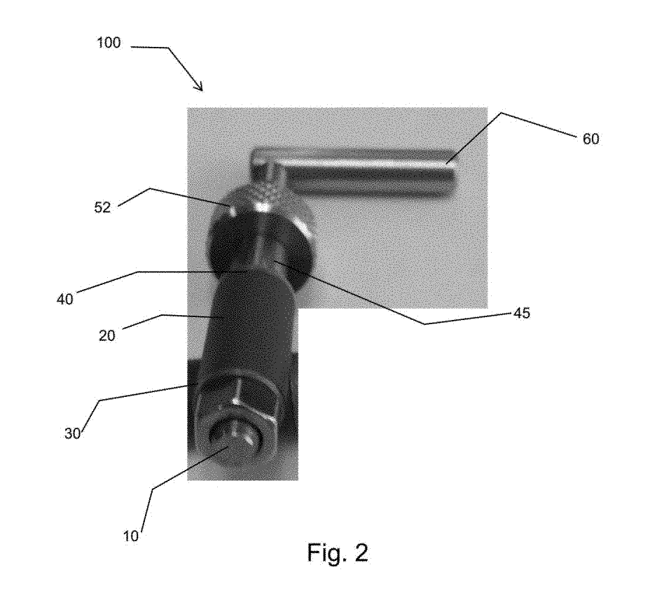

The lower fixer 30 is disposed at the lower end of the base rod portion 10 so as to be fixed to the base rod portion 10 and to limit moving of the lower end of the rubber tube portion 20 in a downward direction as shown in FIG. 2.

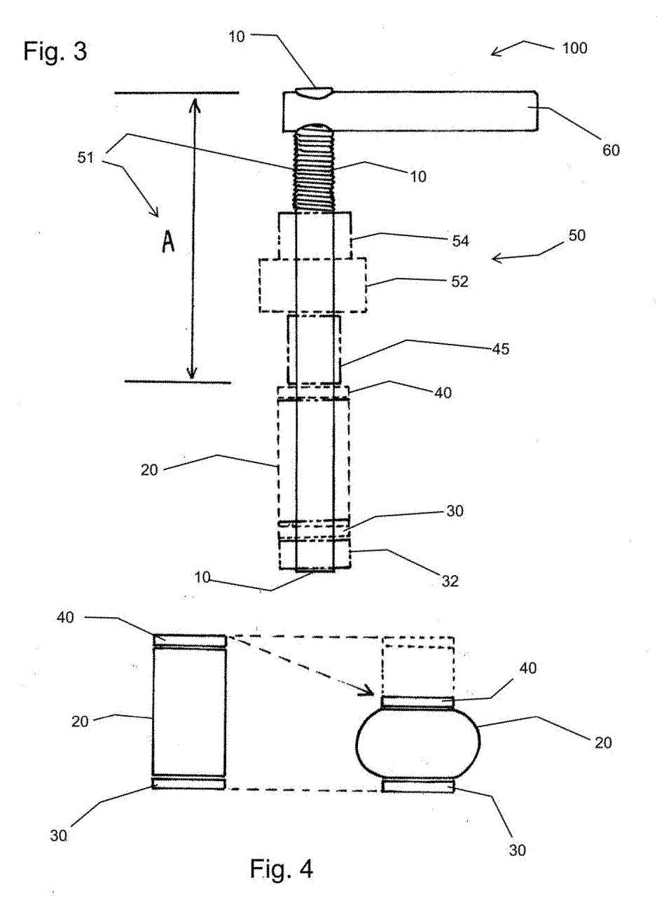

The upper fixer 40 disposed at a position of the base rod portion 10 where the upper end of the rubber tube portion 20 is located, so as to be fixed movably to the base rod portion 10 and to limit moving of the upper end of the rubber tube portion 20 in an upward direction as shown in FIGS. 1 and 3.

The lower fixer 30 and the upper fixer 40 are configured for fixing a distance therebetween, so as to press the rubber tube portion 20 lengthwise from both of the lower and upper ends to a specific length and thus to make the rubber tube portion 20 bulge to a specific diameter, so that the bulged rubber tube portion 20 blocks and seals an external pipe (not shown) from inside as shown in FIG. 4. That is, the lower portion of the pipe ML plug is inserted into the external pipe, and then the distance between the lower fixer 30 and the upper fixer 40 is decreased by compressing, so that the bulged rubber tube portion 20 blocks and seals an external pipe.

The pipe ML plug 100 may further comprise an adjuster 50 provided around the base rod portion 10 and configured for pressing on and holding the upper fixer 40 so as to shorten the length of the rubber tube portion 20 and to bulge the diameter of the rubber tube portion 20 to a specific diameter, by engaging with the base rod portion.

The adjuster 50 may comprise a plurality of male threads 51 and a plurality of female threads (shown).

The plurality of male threads 51 are provided on a portion of an outer surface of the base rod portion 10 between the upper end and the lower end of the base rod portion 10 as shown in FIG. 3. Actually, the plurality of male threads 51 are provided on a portion “A” of an outer surface of the base rod portion 10, so that the adjuster 50 can drive along the base rod portion 10 and compress the rubber tube portion 20 long enough to bulge to a diameter large enough to block and seal the external pipe.

The plurality of female threads are provided on a portion of an inner surface of the adjuster 50.

The adjuster 50 engages the base rod portion 10 through the male and female threads, so as to adjust the position of the upper fixer 40 along the base rod portion 10.

The adjuster 50 may be made integrally and monolithically with the upper fixer 40.

The adjuster 50 may further comprise a first handle portion 52 provided on an outer surface of the adjuster 50 and configured to be held by a user hand for rotating the adjuster 50. For the purpose, the first handle portion 52 may have a rough outer surface for facilitating the finger grip.

The adjuster 50 may further comprise a second handle portion 54 provided on an outer surface of the adjuster 50 and configured to be held by a mechanical tool such as a wrench for rotating the adjuster 50.

Alternatively, the adjuster 50 may comprise a first handle portion 52 and a second handle portion 54. The first handle portion 52 is provided on an outer surface of the adjuster 50 and configured to be held by a user hand for rotating the adjuster 50, and the second handle portion 54 is provided on an outer surface of the adjuster 50 and configured to be held by a mechanical tool such as a wrench for rotating the adjuster 50. The second handle portion 54 may be disposed on top of the first handle portion 52 in the length direction of the adjuster 50.

Actually, in most works, hand-tightening with a bare hand with the first handle portion 52 is enough to rotate the adjuster 50 tightly against the upper fixer 40 and the rubber tube portion 20.

The rubber tube portion 20 may have an outer diameter substantially same as a diameter of the lower and upper fixers 30, 40.

The rubber tube portion 20 may be configured configured to be pressed lengthwise to bulge to a diameter larger than an original diameter.

The pipe ML plug 100 may further comprise a hexagon nut 32 disposed fixedly to the lower end portion of the base rod portion 10 for facilitating to hold or rotate the base rod portion 10.

The base rod portion 10 may comprise a plurality of male threads 51 over an entire length. In such a case, the rubber tube portion 20 has an inner diameter and thus is still free to slide along the base rod portion 10.

The pipe ML plug 100 may further comprise a lever handle 60 perpendicularly provided at a top end of the base rod portion 10, so as to be configured that a user holds or rotate the lever handle 60 with a single hand, exerting 250 psi even without a tool, which is much more than 75 psi, the regular pressure present in most works. Since the lever handle 60 is bent in such a way, the pipe ML plug 100 may be caught somewhere even if the user drops it by mistake.

In the prior arts, since there is so such feature, the user needed two hands to do something about the plugs. Comparing the prior art situation with the present invention, it would be clear how the pip ML plug is inventive.

Another aspect of the invention provides that the base rod portion 10 may further comprise a longitudinal hole (not shown) through the entire length thereof.

The pipe ML plug 100 may further comprise an L-shaped pipe portion (not shown) and a cap portion (not shown).

The L-shaped pipe portion has a lower end vertically connected to the upper end of the base rod portion and an upper end opening horizontally.

The cap portion is disposed at the upper end of the L-shaped pipe portion so as to close or open the upper end of the L-shaped pipe portion.

The upper end is configured to be connected to an air or water or any fluid supplying pipe for leak testing in the external pipe to which the lower portion of the pipe ML plug is inserted and connected.

The L-shaped pipe portion may be connected to the base rod portion 10 through male and female threads.

The pipe ML plug 100 may further comprise a spacer 45 disposed between the adjuster 50 and the upper fixer 40 as shown in FIGS. 1 and 3. The spacer 45 is configured to slide freely on the base rod portion 10. Its purpose is to provide extra extension to a compressing distance of the rubber tube portion 20 even when the adjuster 50 reaches the lowest portion with the male threads in the region “A”.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A pipe ML plug comprising:
a base rod portion of a first length having a lower end and an upper end;
a rubber tube portion disposed around a length portion of the base rod portion and at the lower end of the base rod portion, having an inner diameter and an outer diameter and extending straight for a second length shorter than the first length of the base rod portion, having a lower end and an upper end, and configured to increase a blocking diameter when compressed lengthwise;
a lower fixer disposed at the lower end of the base rod portion so as to be fixed to the base rod portion and to limit moving of the lower end of the rubber tube portion in a downward direction; and
an upper fixer disposed at a position of the base rod portion where the upper end of the rubber tube portion is located, so as to be fixed movably to the base rod portion and to limit moving of the upper end of the rubber tube portion in an upward direction,
wherein the lower fixer and the upper fixer are configured for fixing a distance therebetween, so as to press the rubber tube portion lengthwise from both of the lower and upper ends to a specific length and thus to make the rubber tube portion bulge to a specific diameter, so that the bulged rubber tube portion blocks and seals an external pipe from inside.

2. The pipe ML plug of claim 1, further comprising an adjuster provided around the base rod portion and configured for pressing on and holding the upper fixer so as to shorten the length of the rubber tube portion and to bulge the diameter of the rubber tube portion to a specific diameter, by engaging with the base rod portion.

3. The pipe ML plug of claim 2, wherein the adjuster comprises:
a plurality of male threads provided on a portion of an outer surface of the base rod portion between the upper end and the lower end of the base rod portion; and
a plurality of female threads provided on a portion of an inner surface of the adjuster,
wherein the adjuster engages the base rod portion through the male and female threads, so as to adjust the position of the upper fixer along the base rod portion.

4. The pipe ML plug of claim 3, wherein the adjuster is made integrally and monolithically with the upper fixer.

5. The pipe ML plug of claim 3, wherein the adjuster further comprises a first handle portion provided on an outer surface of the adjuster and configured to be held by a user hand for rotating the adjuster.

6. The pipe ML plug of claim 3, wherein the adjuster further comprises a second handle portion provided on an outer surface of the adjuster and configured to be held by a mechanical tool such as a wrench for rotating the adjuster.

7. The pipe ML plug of claim 3, wherein the adjuster further comprises:
a first handle portion provided on an outer surface of the adjuster and configured to be held by a user hand for rotating the adjuster; and
a second handle portion provided on an outer surface of the adjuster and configured to be held by a mechanical tool such as a wrench for rotating the adjuster,
wherein the second handle is disposed on top of the first handle in the length direction of the adjuster.

8. The pipe ML plug of claim 1, wherein the rubber tube portion has an outer diameter substantially same as a diameter of the lower and upper fixers.

9. The pipe ML plug of claim 8, wherein the rubber tube portion is configured to be pressed lengthwise to bulge to a diameter larger than an original diameter.

10. The pipe ML plug of claim 1, further comprising a hexagon nut disposed fixedly to the lower end portion of the main pipe portion for facilitating to hold or rotate the main pipe portion.

11. The pipe ML plug of claim 1, wherein the base rod portion comprises a plurality of male threads over an entire length.

12. The pipe ML plug of claim 11, further comprising a lever handle perpendicularly provided at a top end of the base rod portion, so as to be configured that a user holds or rotate the lever with a single hand, even without a tool, up to 250 psi.

13. The pipe ML plug of claim 11, wherein the base rod portion further comprises a longitudinal hole through the entire length thereof.

14. The pipe ML plug of claim 13, further comprising:
an L-shaped pipe portion having a lower end vertically connected to the upper end of the base rod portion and an upper end opening horizontally; and
a cap portion disposed at the upper end of the L-shaped pipe portion so as to close or open the upper end of the L-shaped pipe portion,
wherein the upper end is configured to be connected to an air-supplying pipe for leak testing in the external pipe to which the lower portion of the pipe ML plug is inserted and connected.

15. The pipe ML plug of claim 10, wherein the L-shaped pipe portion is connected to the base rod portion through male and female threads.
